(19) United States
(12) Patent Application Publication
(10) Pub. No.: US 2010/0251610 A1
(43) Pub. Date: Oct. 7, 2010

(54) BLIND SYSTEM

(75) Inventor: Jacobus Christiaan Gerardus Maria Ruiter, Zoetermeer (NL)

Correspondence Address: YOUNG & THOMPSON, 209 Madison Street, Suite 500, Alexandria, VA, 22314, US

(73) Assignee: CROPSS HOLDING B.V., Andijk (NL)

(21) Appl. No.: 12/675,831

(22) PCT Filed: Aug. 28, 2008
(86) PCT No.: PCT/NL08/50570

§ 371 Date: Mar. 1, 2010

(30) Foreign Application Priority Data
Aug. 28, 2007 (NL) 2000833

(51) Int. Cl. E06B 9/386; E06B 9/36; E06B 9/38; A01G 9/00

(52) U.S. Cl. 47/17; 160/178.1 R; 160/178.1 V; 160/127

(57) ABSTRACT

Blind system comprising a number of strip elements or blinds. Each strip element comprises a bilaterally light-translucent material which, on the side directed towards the outside world, is infrared-reflective. This material is also preferably ultraviolet-reflective or capable of transforming ultraviolet light into a different (visible) frequency. The blind strips may be formed of horizontal and vertical strip elements and it is also possible to mount these on a roll so that a retractable shade can be achieved. The blinds are preferably mounted on the interior of a building. The strip elements comprise a number of superimposed layers with different specific optical properties, the combination of which results in the desired light effects.

The present invention relates to a blind system. Such a blind system is described in U.S. Pat. No. 3,645,317.

There is an ever-increasing desire to control the temperature in a building by the most effective means energy-wise. To this end, extensive insulation measures are taken and it is known that the windows of buildings are provided with infrared-reflective coatings. This gives such windows a dark appearance. This is often not considered as attractive and, moreover, there is the disadvantage in the absence of sunlight that the space behind such coated windows is particularly somber. This means that in such cases it is necessary to provide lighting, thus increasing energy consumption in such a building, apart from the fact that it is often considered unpleasant to work in unnatural light conditions. U.S. Pat. No. 3,645,317 describes a Venetian blind system, whereby visibility from the inside and outside is not hindered, i.e. that the Venetian blind system is translucent. Viewed from both the outside and the inside, the blinds are provided with a reflective coating which, in part, reflects the infrared radiation originating from outside. In a partially closed position, a portion of the infrared radiation is reflected and can allow light from the outside to enter the space through the open part of the blinds. In a fully closed position of the blinds, full reflection of the infrared light occurs. Above all, in this situation, the blind directed from the outside to the inside is relatively non-transparent to any remaining light. With this construction, infrared light is reflected and partially absorbed, as is any remaining light.

A polarizing element formed of multiple layers is known in U.S. Pat. No. 6,185,039 B1. These polarizing elements are provided with a reflective coating. Polarization will cause a portion of the light to be freely transmitted and another portion to be absorbed.

DE 10.164.425 A1 describes glazing, whereby a blind construction is mounted on the exterior. The object of this construction is to cause a reduction in the reflection of the infrared light.

In constructions which act with absorption and which are mounted on the interior of the building, the absorption will still generate heat within the building. Moreover, all constructions that act on infrared absorption/reflection known in the present art restrict the transmission of the remaining portion of the light spectrum.

The object of the present invention is provide a structure which enables to more effectively control the climate within a building without the disadvantages as described hereinbefore.

This object is achieved in a blind system, with the features given in claim 1.

It is proposed, according to the present invention, to achieve infrared reflection not at the pane of the building, but preferably within a blind system being inside the building. In the event infrared reflection is not desirable, i.e. in the winter and under cloud overcast conditions, the strip elements of the blind system can simply be operated to an ‘open position’. The ‘open position’ is understood to mean the position whereby the blind system is not effective for the user. The closed position is the position whereby the venetian blind system is effective. However, since the strip elements are composed of bilaterally light-translucent material, the user still has visibility to the outside and light is still transmitted into the space in question. As previously indicated, although the blinds are preferably mounted on the interior of a building, it may also be preferable under certain conditions to mount the blinds on the exterior of a building, or between the panes of double glazing.

More specifically, the blinds are formed in such a manner that the blinds are fully light-translucent from the inside to the outside and, from the outside to the inside primarily only reflect infrared light. In other words, light with a frequency between approximately 300-800 nm is permitted to pass in substantial quantities from the exterior to the interior, whereas light with a frequency exceeding approximately 800 nm is reflected. Because reflection is used and not absorption, no heating occurs.

Apart from reflecting infrared light, according to one embodiment of the present invention the blinds are preferably formed to exclude the transmission of ultraviolet light. This can be achieved by providing the blinds with means to both reflect and absorb UV-light. Combinations are also possible whereby, in addition, rights are claimed for an alternative embodiment wherein ultraviolet light is transformed into visible light.

According to the present invention, a strip element is composed of foil material. This foil material can be provided with a foil for achieving the desired optical effect. However, it is also possible to apply additives to the foil during production in order to achieve these effects.

In addition, it is also possible to change the optical properties of the foil material by applying an electric field. An example of this is the application of a liquid crystal such as, among others, PDLC (polymer dispersed liquid crystal). This relates here to both the nematic version and the ferro-electric version of the liquid crystal.

In general, such coatings and additives will be effective over a large range of the light spectrum. According to one specific embodiment of the invention, which may be combined with the above described embodiment, the foil may comprise structures such as multilayer foils. This makes it possible to influence a very specific part of the light spectrum without affecting the transmission of light and the light spectrum outside.

Each individual layer is preferably formed with different specific optical properties and the desired optical properties of the blind system may be achieved by a combination of these layers.

Each layer is formed of a large number of sublayers and in grouped sublayers forming a layer and is thus able to reflect a specific limited light frequency. By placing a number of such layers consecutively and with different frequency ranges, a greater light range can be reflected, such as a range indicated above exceeding 800 nm. The superimposed layers form a number of interrelated circuits, wherein each circuit can reflect a critical range. Such a construction is essentially different to a coating, wherein, in general, (specific parts of the) light is/are filtered by means of absorption. Moreover, in the case of systems based upon absorption, not only does the restriction of the amount of infrared radiation occur, but the total quantity of light over the entire spectrum is also reduced. This means that such a system is not acceptable in spaces wherein light is particularly desired, but not heat radiation. An example of this is a conditioned propagation space or living space and accommodations in warmer climates.

A thickness of 50-500 nm is indicated as an example for each layer of foil. For example, the foil material may comprise a polyester material. This means that the actual optical properties will depend on the user of the building. In this way, it is possible to apply different blinds in a conference room than in spaces where computer display units are used. Yet another example is the application in horticultural greenhouses. Here, requirements regarding visible light will depend on the crops grown and the growth stage of those crops. Generally speaking, in such cases, the quantity of light is of great significance to the crop yield. Conversely, infrared radiation is often undesired since this results in a large increase in temperature within such propagation spaces. In particular, the blind system according to the present invention is used in the roof structure of horticultural greenhouses. More specifically, the blinds border directly on the sloping elements of the roof construction. Likewise, it is also possible to mount the blind system directly above the roof construction of a horticultural greenhouse.

The strip elements can be placed in any position in order to achieve the blind system. The use of either horizontal or vertical blinds is conceivable. In both cases, it is possible, by keeling over the individual blind elements with an essentially fixed titling axis, to obtain both an open and a closed position. It is also possible to collectively reposition the blinds, thus enabling said blinds to be removed entirely from view. Another possibility is to mount the blinds, for example, on laterally positioned carriers in order to obtain a retractable shade. The blinds preferably comprise a bilaterally light-translucent carrier, wherein a foil layer is applied on one side which, as described hereinbefore, only possesses infrared-reflecting properties in one direction.

The invention also relates to a building, such as a cultivation space in which said blind systems are mounted.

It is possible to provide the above-described foil layer with coatings which further influence the visible light spectrum and/or light intensity. Such coatings may also be applied to the exterior of the blinds and, more specifically, preferably on the side directed towards the interior of the building.

Additionally, it is also possible to provide each strip element with a structure, color and printing. Such options will depend on the requirements of the user. Moreover, the blinds can be used in combination with glazing techniques, wherein the glazing partially influences the incidence of light, for example, by either reflecting a portion of the ultraviolet light and/or a portion of the infrared light.

According to another advantageous embodiment of the invention, the blind system can be constructed in such a manner that the light incident onto the structure is converted into electrical energy with photovoltaic systems. This may be achieved by providing the blind system itself with a photovoltaic system, or by reflecting the light or a specific portion thereof towards a collector provided with such a photovoltaic system. Moreover, if the light is reflected to a collector, the heat (infrared radiation) which is present in the collector can be converted to thermal energy (liquid collector).

The invention will be described in more detail below with the exemplary embodiments shown in the drawing, in which:

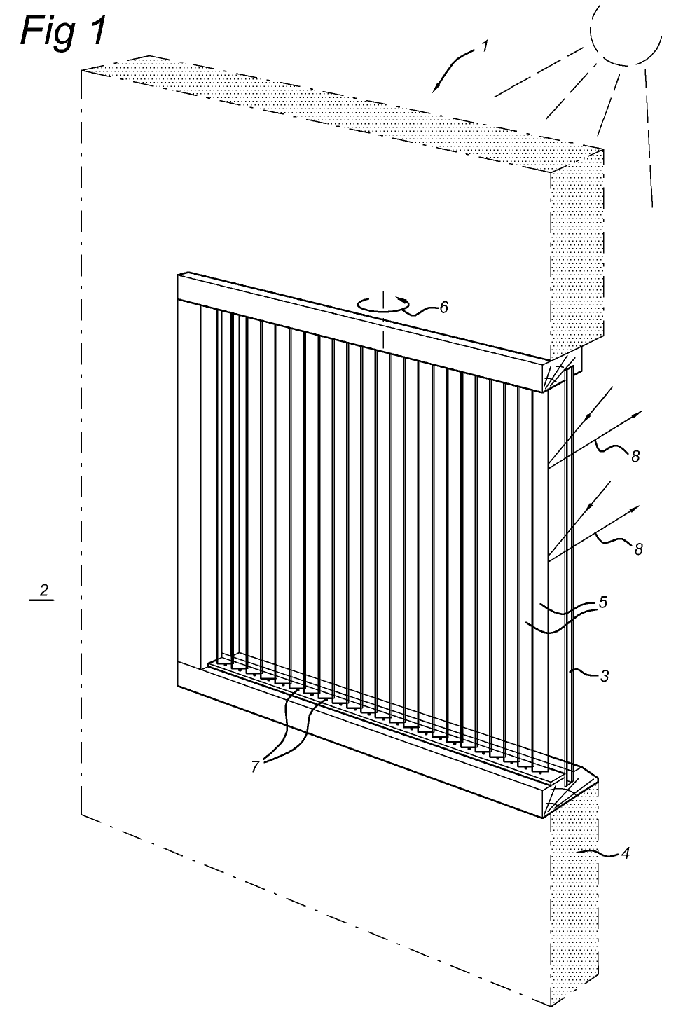

FIG. 1 is a schematic arrangement for vertical blinds;

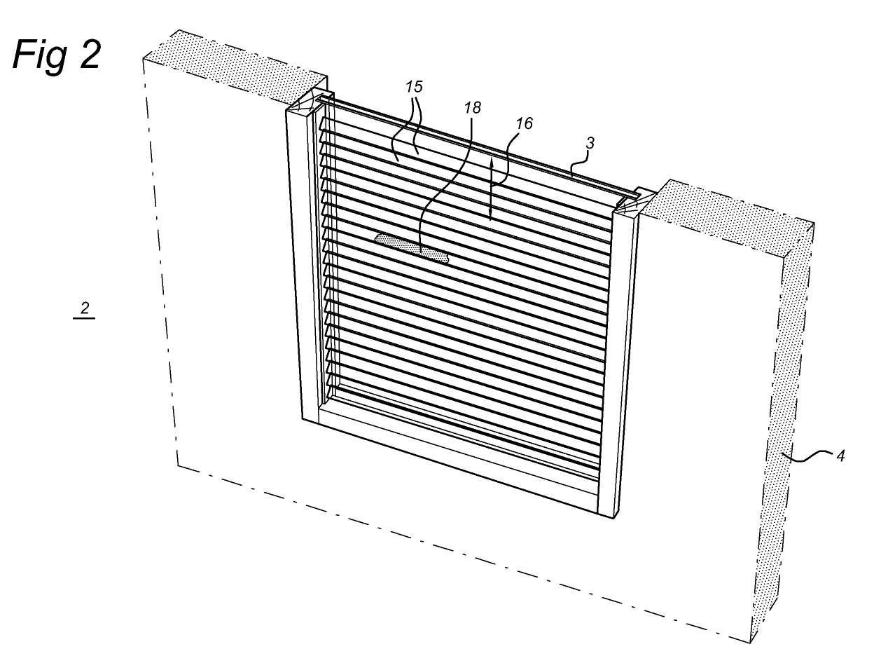

FIG. 2 is an arrangement with horizontal blinds;

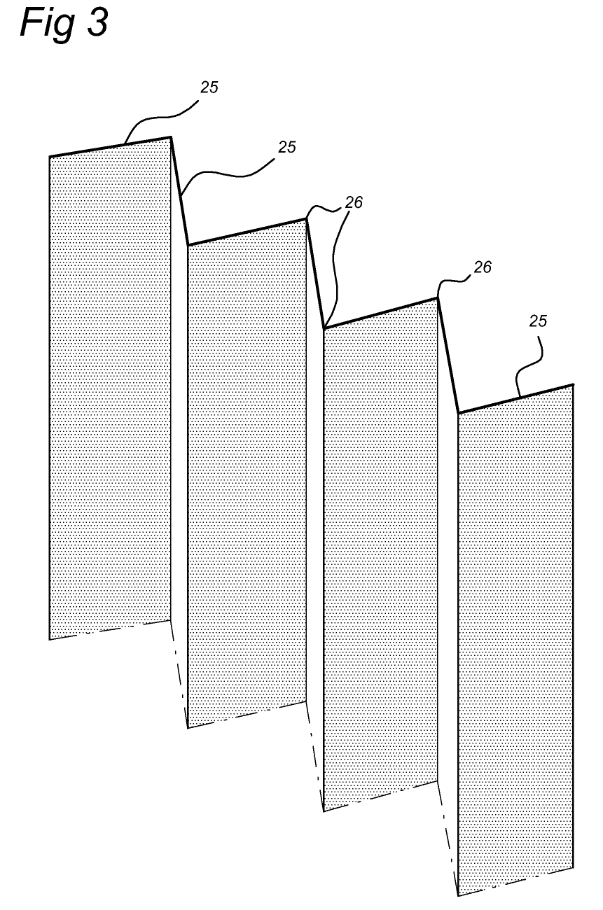

FIG. 3 is a folded blind assembly;

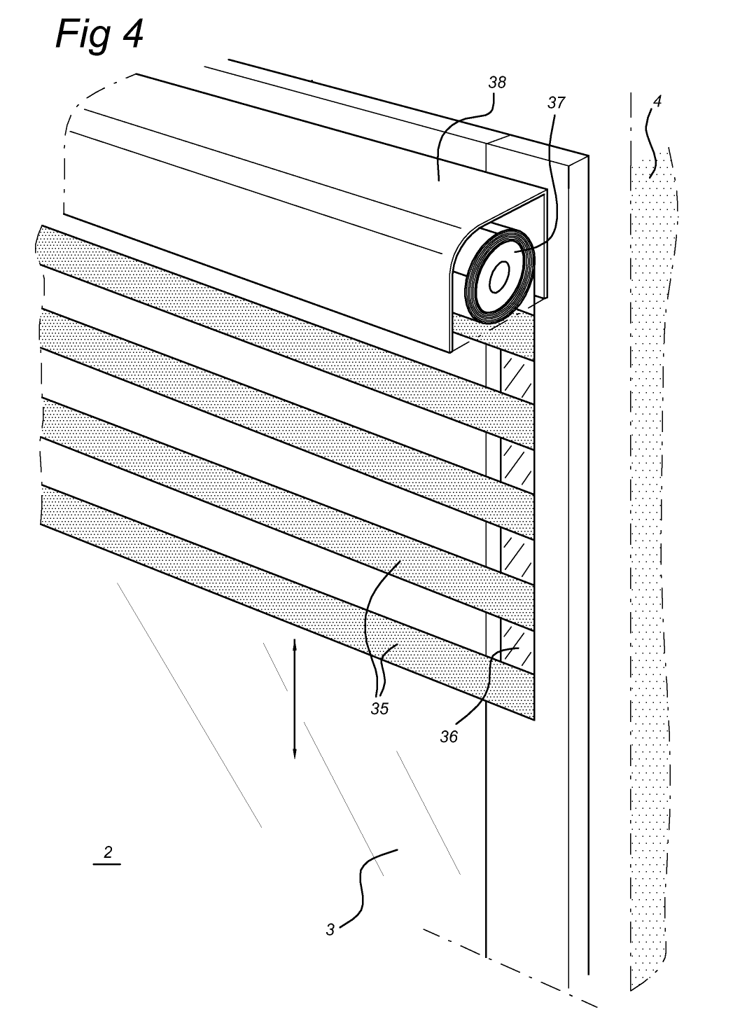

FIG. 4 shows the strip elements of blinds used in a retractable shade;

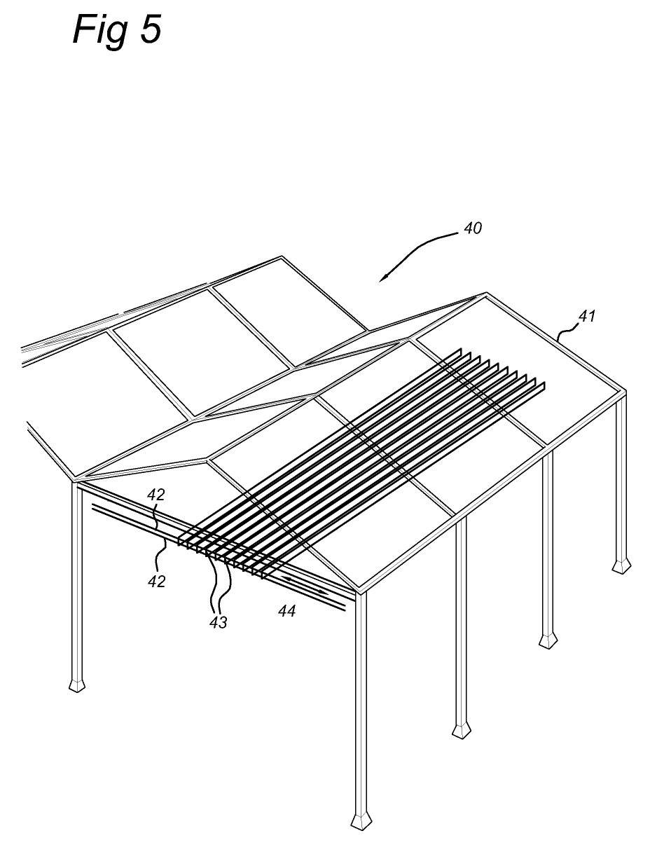

FIG. 5 shows a further application of the current invention; and

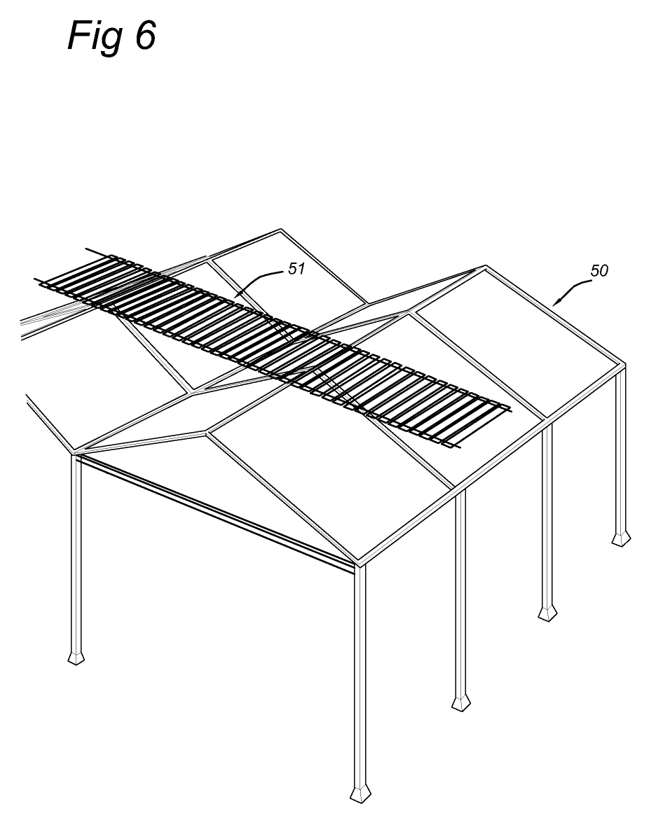

FIG. 6 shows another alternative proposal according to the invention.

Numeral 1 in FIG. 1 indicates a building in its entirety. The interior is indicated by numeral 2. This is closed off from the exterior by a wall 4 in which glazing 3 is applied.

A blind system according to the invention is mounted to the interior of the glazing which comprises strip elements or blinds 5, each being rotatable along an axis 7 in the direction of arrow 6. This makes it possible for the (possibly partially overlapping) strip elements 5 to provide full closure of space 2 to the exterior and, conversely, to provide for a full unhindered view of the outside (in an incidence direction of the light) when rotated. In the closed position, light entering from the outside (the opposite direction) will pass through the strip elements 5 completely. The strip elements 5 in this example of an embodiment are formed of material that is translucent to visible light. A number of foil layers is applied to the translucent material. These layers of foil are combined and formed in such a manner that infrared light originating from the outside is reflected and prevented from passing through the material. To achieve this, each layer of foil is formed of a number of sublayers (not shown). Each group of sublayers, thus forming a layer, is capable of reflecting a certain frequency or frequency range of light. By superimposing such foil layers with different reflection frequencies, a much larger frequency range can be obtained which reflects a certain frequency range without absorption phenomena and without affecting the visibility of any remaining light spectrum. According to the present invention, this range is selected above the 650 nm and, in particular, above the 800 nm, more specifically between 800 and 1200 nm. This means that infrared radiation is blocked, whereas the passage of any other light is only very partially hindered, or not at all.

The layers of foil are mounted on the bilaterally light-translucent blinds constructed as a carrier. This is indicated by arrow 8. This means that heat radiation from the sun is not absorbed inside the building, which makes it unnecessary or less necessary to cool the building. The extent of reflection can be adjusted by tilting the strip elements 5 and, if necessary, partial heating of the building can be achieved by allowing the passage of light that is not reflected by the strip elements. The automatic climate control of the building can be achieved by electrically operating the strip elements.

If cooling is not relevant, the blind strips may be opened fully so that the user has an unhindered view of the outside without the space in which he is in appearing dark.

FIG. 2 shows an alternative construction to the construction shown in FIG. 1. The building is unmodified, but the strip elements are indicated at 15. These can be moved upwards and downwards in the direction of arrow 16. In other words, effectuating either the full or partial closure of the glazing 3. If desired, the horizontal strips 15 can be made to rotate on their horizontal axes. Numeral 18 indicates a coating applied to the strip elements on the inside 2 of the building, thus enabling the further manipulation of the incidence of light. As in the previous exemplary embodiment, the strip elements can be formed in such a manner as to block out ultraviolet light, i.e. to prevent it from entering the building. This can be achieved either by absorption or by reflection, or by transforming ultraviolet light into visible light. Combinations of these various mechanisms are also conceivable.

FIG. 3 shows an alternative embodiment, wherein the strip elements, indicated by 25, are hingeably connected with each other at 26. A light-translucent opening can be covered by unfolding the strips or be uncovered by folding the strips. The strip elements 25 can be formed in a manner as described hereinbefore, based on the use of the strip elements 5 and 15.

FIG. 4 shows an alternative embodiment, wherein the strip elements, indicated by 35, are interconnected by means of a flexible strip 36 or a translucent carrier across the entire width thereof.

37 indicates a roll onto which the formed row of strip elements can be wound and unwound. This roll 37 is incorporated in a horticultural greenhouse 38 which, in this example, is located on the inside of the building 2. It is also possible to mount these on the exterior. The strip elements 35 may possess the above-described properties for those strip elements.

The strip elements may also be mounted on the carrier with an interstice on the carrier with the object of, for example, reflecting not 100% of the infrared radiation but only 50%, the interstice being as equally wide as the strip.

FIG. 5 shows a further variant of the invention. 40 indicates a greenhouse construction with roof covers 41. Two tension cables 42 are mounted beneath the covers onto which a large number of blind strips 43 are mounted. The lowermost tension cable 42 for example, is stationary, whereas the uppermost tension cable 42 can be moved to-and-fro in the direction of arrow 44. In this way, the blind strips are more or less positioned flatly on top of each other and in their most extreme position can allow the unhindered passage of light and, in the other most extreme position (laying on top of each other), fully reflect the infrared portion of the light. It will be readily apparent that such a construction may also be achieved in such a manner that such construction extends axially parallel to the slope of the roof structure 41 of the horticultural greenhouse.

FIG. 6 also shows a greenhouse structure, indicated entirely by 50. In this alternative embodiment, a corresponding blind system according to the construction in FIG. 5 and indicated by 51 is mounted and fixed to the exterior of the greenhouse by means not further specified in any particular manner. This means that the effect of any absorption of light that always takes place in the blind strips 43, being the heating of the greenhouse, can be neglected completely since the blind system 51 is mounted on the exterior of the greenhouse. Of course, such a system may also be used in any other building in which the present invention can be applied.

With the present invention, the climate in a building can be influenced in a relatively simple and cost-effective manner without the necessity to take expensive measures for this to be achieved. The cooling/heating capacity of a building can be restricted considerably, whereas the climate is considerably improved.

After the above, those skilled in the art will be readily aware of other alternative embodiments which lie within the scope and spirit of the invention and for which the following is claimed.

1-17. (canceled)

18. Blind system comprising a number of adjacent strip elements which can be moved from a closed position to an open position, wherein each of the strip elements is formed of a foil material that is translucent in a direction of the incidence of light and, in the opposite direction of light incidence, is made infrared-reflective on at least one side, wherein in said opposite direction of the incidence of light, the foil material is made translucent and infrared-reflective, said foil material comprising a number of layers of foil material, wherein each layer is able to reflect a specific limited light frequency and is formed of a large number of sublayers, wherein said number of layers is placed consecutively and having different frequency ranges to reflect a greater light range.

19. Blind system according to claim 18, wherein the strip elements are formed to block ultraviolet light on the side opposite to the direction of the incidence of light.

20. Blind system according to claim 18, wherein each layer possesses specific infrared reflecting properties in relation to the other layers.

21. Blind system according to claim 18, wherein said foil material is embodied to convert ultra violet light to visible light.

22. Blind system according to claim 18, wherein the strip elements are composed of vertical strip elements.

23. Blind system according to claim 18, wherein the strip elements are hingeably connected along the longitudinal extension thereof.

24. Blind system according to claim 18, wherein the strip elements form part of a retractable shade.

25. Blind system according to claim 24, wherein the distance between the strip elements can be varied for the purpose of changing the coverage achieved by those strip elements.

26. Blind system according to claim 18, wherein the strip elements comprise horizontal strip elements.

27. Blind system according to claim 18, in combination with a photovoltaic system.

28. Blind system according to claim 27, wherein said photovoltaic system is included in a collector mounted at a distance from the blind system.

29. Blind system according to claim 27, wherein said photovoltaic system is included in a collector mounted at a distance from the blind system.

30. Building comprising glazing and a blind system mounted to the building side of the glazing, wherein each layer is able to reflect a specific limited light frequency and is formed of a large number of sublayers, wherein said number of layers is placed consecutively and having different frequency ranges to reflect a greater light range.

31. A building according to claim 30, wherein the blind system is constructed for the variable and partial covering of the opening of the glazing.

32. Building according to claim 30, wherein the strip elements on the opposing side of the glazing are provided with a coating which effects visible light.

33. Building according to claim 30 comprising a greenhouse construction.
